(19) United States
(12) Patent Application Publication
(10) Pub. No.: US 2007/0246529 A1
(43) Pub. Date: Oct. 25, 2007

(54) Smart Card with Touchpad

(75) Inventors: Cyril Lalo, Paris (FR); Philippe Guillaud, Paris (FR)

Correspondence Address: RATNERPRESTIA, P O BOX 980, VALLEY FORGE, PA, 19482-0980, US

(73) Assignee: AUDIOSMARTCARD INTERNATIONAL SA, Boulogne Billancourt (FR)

(21) Appl. No.: 11/630,021

(22) PCT Filed: Jun. 22, 2005
(86) PCT No.: PCT/FR05/50482

§ 371 Date: Dec. 18, 2006

(30) Foreign Application Priority Data
Jun. 29, 2004 (FR) 0451358

(51) Int. Cl. G07F 7/10

(52) U.S. Cl. 235/380

(57) ABSTRACT

The invention relates to a self-powered card of standardized format including keys (201) placed on at least one zone not allocated by the standardized format, a functional module (203) and an activation module (202) designed to activate the functional module (203) when a correct code is entered by means of the keys (201). The invention secures the use of such cards.

The present invention relates to a smart card with a standardized format.

Such cards, especially those standardized by the ISO 7810 and/or 7816 standards, are generally used as to interface with apparatuses designed to perform operations requiring user identification. This identification is conventionally obtained by setting up a contact link or contactless link between the card and the apparatus. The card is then subjected to electrical or magnetic signals in such a way that data present in the card is read. The reading of this data enables, for example, the identification of the user.

Such cards generally include several identification elements enabling data in the card to be read. These identification elements are for example especially a card number, a magnetic track, a semiconductor component or “chip” including data pertaining to a secret code. If a chip is used, signals penetrate the card and the chip gives a response. These cards, which have no power supply of their own, work only with apparatuses designed to carry out operations and are passive in the absence of such an apparatus.

The weakness of such cards used for identification is that, owing to their passivity, they may be interrogated in such a way as to reveal the data stored therein. Thus, it is well known that these cards are pirated, for example, through the sending of various questions in the form of electrical or magnetic flows toward the chip. These flows are analyzed by the chip and a response is provided. The contents of the chip, for example a secret code, can be according to the responses from the chip. In the present situation, the use of a secret code, although it gives the user a sense of security, does not provide a sufficient guarantee against fraud.

The pirating of the magnetic strips in such cards is also widespread as is the fraudulent use of card numbers, for example on the Internet.

These various forms of piracy lower the users' confidence in such cards and therefore hamper their spread, especially for use in payment operations.

To increase the security of such payment cards, there are known ways of using a card provided with a touchpad, this touchpad being used to enter a secret code to activate the card. However, having a touchpad on such a card raises two conflicting problems: firstly the card needs to be large enough for ergonomic reasons and secondly its size is inconvenient if the touchpad has to be laid out in such a way as to make the card compatible with international standards relating to the format of payment cards. The zones known as free zones according to the standards are few, and their surface area is limited.

The invention provides a remedy to the above-mentioned drawbacks by enabling increased security for a card, as presented in the introduction, that is provided with a touchpad ensuring compliance of the card with standards.

The invention relates to a card of standardized format comprising keys, a functional module and an activation module designed to activate the function module when a determined code is entered by means of the keys, said keys being positioned in a single row situated close to the edge in such a way that the keys are in a zone left free under the standards.

According to one embodiment, the card has six keys at most.

According to another embodiment, each key has a domed shape, making the keys easier to differentiate by touch.

According to one embodiment, the keys are of a diameter, for example between 6 and 8 mm, sufficient to make them easy to handle by touch.

In one embodiment, the determined code to be entered is a sequence of five characters.

According to another embodiment, the code is a sequence of letters, each key corresponding to one or more letters.

In one embodiment, the card has a module for disabling the activation module, said activation module being disabled for a predetermined disablement period, for example with a value of five seconds, either after a predetermined number of incorrect codes, for example 3, have been entered consecutively or following the entry of a sequence of given size, for example 15 characters, this sequence not comprising the correct code.

In another embodiment, the predetermined disablement period is increased, for example by increments, at each fresh entry of an incorrect code or at the entry of a completely new sequence that does not include the correct code.

In one embodiment, the predetermined disablement period has a boundary value, equal for example to 30 seconds.

In one embodiment, the disablement period returns to its initial value upon the entry of the correct code.

According to another embodiment, the card has means to emit a first sound that is characteristic of the pressure on a key as well as means to emit a second sound that is characteristic of the entry of the correct code, the two sounds being differentiated.

In one embodiment, the card has means to modify the code.

In another embodiment, the functional module includes an acoustic module to emit an acoustic signature.

According to one embodiment, the card is such that it meets the specifications of the ISO 78 10 and/or ISO 7816 standards.

Other features and advantages of the invention shall appear from the following description, made on a descriptive and non-exhaustive basis, with reference to the drawings here below, of which:

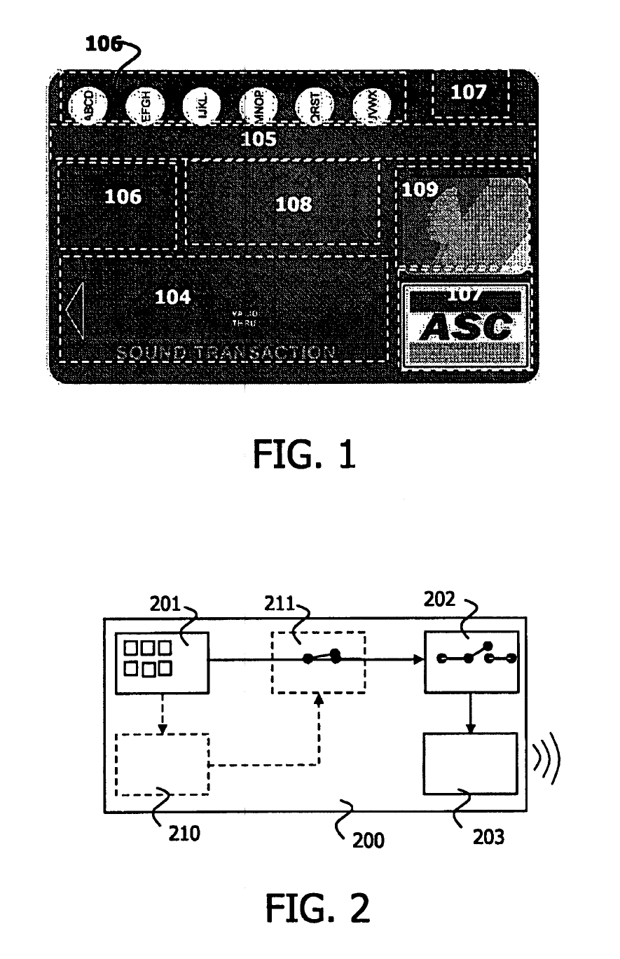

FIG. 1 shows a card according to the invention;

FIG. 2 is a schematic diagram of the card illustrating the working of the card according to the invention.

According to FIG. 1, a card 100 according to the invention comprises a certain number of standardized zones 104 to 109. Such zones include especially an embossed zone 104, a zone for the magnetic tracks 105 situated on the reverse side, a zone for the chip 106, a zone to identify the organization having delivered the card 107, a zone for the customer of said organization 108, a zone 109 for a hologram.

Keys 101 are present on a zone 110 not allocated by the standard. These keys 101 are used to enter a code. The keys are laid out in a single row situated near the large side of the card. The zone thus occupied by the keys is left free by the standard.

As shown in FIG. 2, the keys 201 are connected to an activation module 202 designed to activate the functional module 203 when a correct code is entered by means of the keys 201.

This activation module 202 activates the functional module 203 when a correct code is entered with the keys. This functional module 203 is advantageously an acoustic module to emit an acoustic signature. This signature guarantees the identification of the user. The use of an acoustic module has many advantages. An acoustic signature can be easily modified. An acoustic signature is generally not resident in a specific machine but is mobile. Furthermore, an acoustic signature is difficult to copy. Indeed, in a computer, i.e. the most common device in which the invention can be advantageously implemented, an acoustic microphone, which is the most widespread acoustic reader, can be listened to by only one software program at a time. It is therefore not possible for a piracy program to copy the acoustic signature.

The functional module 203 of the card may also include a GPS function or be an access-authorizing module active when the card is inserted into a reader, etc.

The card 100 according to the embodiment proposed in FIG. 1 has six buttons. Indeed, this number of buttons fits into the non-standardized zone 110 of the ISO cards without impairment to the accessibility and ergonomy of the buttons which conventionally have a diameter of 6 to 7 mm. A problem corollary to the use of six keys for entering a code is that the possibilities of the code are reduced. Thus, according to one embodiment, the code to be entered has five characters. In this way, the probability is close to that obtained with a four-character code on a ten-key digital pad. The number of possibilities is 6ˆ5=7776 whereas it is 10ˆ4=10000 with a digital pad.

Each of the six keys 101 corresponds for example to a set of four letters, as shown in FIG. 1. This characteristic makes it possible to propose codes that are words and, therefore, easier to memorize.

In FIG. 1, the keys are situated at the top left part of the card and along the upper edge. This makes it easy for the user to enter the code easily with the thumb when the card is given a 90-degree rightward turn. The ergonomy of the entry is thus ensured.

The card advantageously has sound elements to emit sounds, especially when the keys are pressed and when a correct code has been entered. This latter case could advantageously give rise to a different sound.

The card advantageously has a time-out module 210. This module 210 may, for example, be activated after a certain number of key tapping operations, for example 5 or 40, without entry of a right sequence of characters including the right code. Within the card, this feature takes the practical form of the presence of a counter of key-pressing actions with a triggering threshold. Beyond such a threshold, the counter then triggers a disabling module 211 which will disable the operation of the activation module 202 for a predetermined period. The predetermined period may, for example, last five seconds. During this disablement period, pressure on the keys is not taken into account and it is advantageous that the pressure on the keys should not activate any sound.

The time-out module 210 may also be such that the disablement period has a duration that increases correspondingly so that, for example, one hour is spent to perform 100 unsuccessful code attempts. This makes it possible to delay the fraud. The disablement period may be increased in increments, for example of a value of five seconds, at each new entry of an incorrect code. The disablement period advantageously has a boundary value, for example equal to 30 seconds, after which it no longer increases even when there is a new entry of an incorrect code. Conversely, the entry of a correct code resets the value of the predetermined disablement period, which therefore resumes its initial value.

The time-out module 210 takes account of all the activations of the keys 201, even accidental ones.

The card may also include a disabling module 211 activated when a right sequence, corresponding to the code, is not entered for the equivalent of three trials, especially after 15 key-tapping operations as in the example given further above. A disabling module 211 of this kind may also be controllable by the user if he wishes to neutralize his card temporarily. This can be implemented in combination with the time-out module 210 presented earlier. It then gets activated after numerous time-out operations, after an excessively large number of keys have been pressed.

Advantageously, the code may be modified. In order to change the code, the user must enter the current code. Then, two possibilities may be implemented. The first possibility consists in entering a new code twice in succession. The second possibility consists in entering a command, for example CH (for “change”), followed by a new code entered twice in succession. A password that is longer than a sequence of five characters may also be used according to the invention.

The card of the invention may include means, in combination with the invention, to fulfill the usual functions generally proposed with cards of this type, for example the use of an identification code entered into a terminal.

The modules of the card according to the invention may implement hardware or software means or a combination of such means. When the implementation is carried out by software means, the invention can use a computer program product including instructions to obtain the modules according to the invention.

1. Card of standardized format comprising keys, a functional module and an activation module designed to activate the function module when a determined code is entered by means of the keys, said keys being positioned in a single row situated close to the edge in such a way that the keys are in a zone left free under the standards.

2. Card according to claim 1, comprising six keys at most.

3. Card according to claim 1, wherein each key has a domed shape, making the keys easier to differentiate by touch.

4. Card according to one of the above claims, wherein the keys are of a diameter, for example between 6 and 8 mm, sufficient to make them easy to handle by touch.

5. Card according to claim 1, for which the determined code to be entered is a sequence of five characters.

6. Card according to claim 5, for which the code is a sequence of letters, each key corresponding to one or more letters.

7. Card according claim 1, comprising a module for disabling the activation module, this activation module being disabled for a predetermined disablement period, for example with a value of five seconds, either after a predetermined number of incorrect codes, for example three, have been entered consecutively or following the entry of a sequence of given size, for example 15 characters, this sequence not comprising the correct code.

8. Card according to claim 7, wherein the predetermined disablement period is increased, for example by increments, at each fresh entry of an incorrect code or at the entry of a completely new sequence that does not include the correct code.

9. Card according to claim 8, wherein the predetermined disablement period has a boundary value, equal for example to 30 seconds.

10. Card according to one of the claims 8 and 9, wherein the disablement period returns to its initial value upon the entry of the correct code.

11. Card according to claim 1, means to emit a first sound that is characteristic of the pressure on a key as well as means to emit a second sound that is characteristic of the entry of the correct code, the two sounds being differentiated.

12. Card according to claim 1, comprising means to modify the code.

13. Card according to claim 1, wherein the functional module includes an acoustic module to emit an acoustic signature.

14. Card according to claim 1, such that it meets the specifications of the ISO 78 10 and/or ISO 7816 standards.
